(19) United States
(12) Patent Application Publication
(10) Pub. No.: US 2019/0050490 A1
(43) Pub. Date: Feb. 14, 2019

(54) PRESENTING CONTEXTUAL USER SUGGESTIONS

(71) Applicant: Google Inc., Mountain View, CA (US)

(72) Inventor: Stefan KUHNE, San Jose, CA (US)

(21) Appl. No.: 14/615,380

(22) Filed: Feb. 5, 2015

(51) Int. Cl. G06F 17/30; G06F 3/0482; G06F 3/0484

(52) U.S. Cl. CPC G06F 17/30876; G06F 3/04842; G06F 3/0482

(57) ABSTRACT

Suggesting applications to a user of a device, includes displaying multiple interfaces on a display of the device, the multiple interfaces respectively corresponding to multiple applications running on the device, determining, from among the multiple interfaces, an interface that is currently in focus on the display, and identifying a first application, from among the multiple applications, that corresponds to the determined interface. Suggesting the applications further includes determining one or more suggested applications, wherein the one or more suggested applications correspond to applications for suggesting to the user in association with the first application, and providing a graphical interface for display, wherein the graphical interface comprises one or more graphical components, each graphical component for switching to a respective one of the one or more suggested applications.

### BACKGROUND

### Technical Field

The present disclosure generally relates to computing devices, and more particularly to suggesting applications and/or content that contextually correspond to applications running on a computing device.

### Description of the Related Art

Modern computing devices allow users to execute multiple applications at the same time. When a user of a computing device opens multiple applications, each application is associated with one or more windows. As the number of applications running on the computing device increases, it becomes increasingly more difficult to navigate between windows of the multiple applications.

Typically, to determine how many applications have been opened, a user opens a dialog box (e.g., by depressing and holding the Alt key and pressing the Tab key on the keyboard) to view their respective icons. The displayed icons, which represent currently open windows, may represent currently open word processing windows, such as word processing documents, web browsers, or spreadsheet programs, to which the user may navigate. However, the displayed icons do not provide any suggestions for additional activities (e.g., applications or content) that may correspond to an application associated with a particular displayed icon.

Accordingly, there is a need for a method and system that provide suggested activities that may correspond with open applications.

### SUMMARY

According to one embodiment of the present disclosure, a computer-implemented method for suggesting applications to a user of a device is provided. In one aspect, the method includes displaying multiple interfaces on a display of the device, the multiple interfaces respectively corresponding to multiple applications running on the device, determining, from among the multiple interfaces, an interface that is currently in focus on the display, and identifying a first application, from among the multiple applications, that corresponds to the determined interface. The method further includes determining one or more suggested applications, wherein the one or more suggested applications correspond to applications for suggesting to the user in association with the first application, and providing a graphical interface for display, wherein the graphical interface comprises one or more graphical components, each graphical component for switching to a respective one of the one or more suggested applications.

According to one embodiment of the present disclosure, a system for suggesting applications to a user of a device is provided. The system includes a processor and a memory comprising processor-executable instructions. The processor is configured to identify display multiple interfaces on a display of the device, the multiple interfaces respectively corresponding to multiple applications running on the device, determine, from among the multiple interfaces, an interface that is currently in focus on the display, and identify a first application, from among the multiple applications, that corresponds to the determined interface. The processor is further configured to determine one or more suggested applications, wherein the one or more suggested applications correspond to applications for suggesting to the user in association with the first application, and to provide a graphical interface for display, wherein the graphical interface comprises one or more graphical components, each graphical component for switching to a respective one of the one or more suggested applications.

According to one embodiment of the present disclosure, a non-transitory machine-readable storage medium including machine-readable instructions for causing a processor to execute a method is provided. The method includes displaying multiple interfaces on a display of the device, the multiple interfaces respectively corresponding to multiple applications running on the device, determining, from among the multiple interfaces, an interface that is currently in focus on the display, and identifying a first application, from among the multiple applications, that corresponds to the determined interface. The method further includes determining one or more suggested applications, wherein the one or more suggested applications correspond to applications for suggesting to the user in association with the first application, and providing a graphical interface for display, wherein the graphical interface comprises one or more graphical components, each graphical component for switching to a respective one of the one or more suggested applications.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example system architecture for providing a graphical interface comprising components associated with applications suggested to a user for running applications;

FIG. 2 is a block diagram illustrating an example client device and server according to certain aspects of the disclosure;

FIG. 3 illustrates an example process for providing a graphical interface comprising components associated with suggested applications;

FIG. 4 is an example illustration of a display screen that includes a graphical interface comprising components associated with suggested applications; and

FIG. 5 conceptually illustrates an example electronic system with which some implementations of the subject technology can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

As stated above, a user of a computing device may open multiple applications, where each application is associated with one or more windows. As the number of applications running on the device increases, it becomes increasingly more difficult to navigate between windows of the multiple applications.

As stated above, displayed icons, which represent currently open windows, may represent currently open word processing windows, such as word processing documents, web browsers, or spreadsheet programs, to which the user may navigate. However, the icons do not provide any kind of window preview, which makes it difficult to determine which icon is associated with which application window.

Moreover, typically after a user opens an application, the user may proceed to open a related application or content item to enable the user to handle a particular task.

Accordingly, it may be desirable to facilitate navigation between multiple applications, and to anticipate the user needs for particular activities, such as other applications or content elements, contextually associated with the opened applications, and which may be based on the user activity information. In this regard, a user may use particular applications in association with other applications. For example, a user may tend to use a calculator application in association with a spreadsheet application, or the user may tend to call a calculator application from the spreadsheet application. In another example, a user may often use a newsfeed application when reading email or browsing through a social networking site. In addition, the user may use particular content or types of content in association with a particular application. For example, the user may use recently created or edited documents when a particular application is open, or when a document is active.

In example aspects, the subject disclosure provides a method for suggesting activities to a user. Multiple interfaces are displayed on a display of the device, the multiple interfaces respectively corresponding to multiple applications running on the device. An interface that is currently in focus on the display is determined from among the multiple interfaces. A first application that corresponds to the determined interface is identified from among the multiple applications. One or more suggested activities are determined by a suggesting application, wherein the one or more suggested activities correspond to applications for suggesting to the user in association with the first application, for example. Suggested content may also be determined by the suggesting application. Here, the suggested content corresponds to content for suggesting to the user in association with the first application. A graphical interface is generated by the suggesting application and provided for display, wherein the graphical interface comprises one or more graphical components, each graphical component providing for switching to a respective one of the one or more suggested activities.

The multiple interfaces can correspond to at least one of windows or browser sessions respectively corresponding to the multiple applications.

The one or more suggested activities can be determined based on prior user history of the first application in association with the one or more suggested activities. Moreover, the one or more suggested activities can be determined based on activities of the user associated with context of the first application. For example, a particular newsfeed or news website may be suggested when a user's email account is active and it is known that the user likes to consume data with the device based on past user activity.

Alternatively or in addition, the one or more suggested activities can be determined based on functionality or other context of the first application.

In exemplary aspects of the subject disclosure, as discussed herein, a graphical component is an item representative of a suggested application to be launched by the user, a suggested file to be opened, a suggested type of content to be opened, or a suggested action or notification to be launched using a corresponding application or file.

In exemplary aspects of the subject disclosure, a graphical component is a task item that corresponds to a task type, which is a type of a suggested activity. For example, task types can be applications, links to networked content, files, or notifications. As such, graphical components arranged in the graphical interface may include apps, online content (e.g., URL), files, notifications (e.g., electronic communications, social networks, online assistants), etc. The number and order of the graphical components included in the graphical interface may be dynamically selected and configured based on user activities, such as the opening frequency of a suggested activity on the computing device and how recent the suggested activity was opened.

In addition, each of the suggested activities can be associated with a weighted value that is calculated based on the user activity. Moreover, the graphical components may be arranged for display to the user in a single graphical surface of the graphical user interface to allow the user to more easily initiate suggested applications, or re-access opened applications that are anticipated to be again of interest to the user.

In one embodiment of the present disclosure, the user activity information includes a frequency of a user running a particular application, how recently the particular activity was opened, and which suggested activities associated with the particular application were initiated by the user.

In one exemplary embodiment, the suggesting application may be locally installed on a computing device or cloud-based on a server. The suggesting application may be triggered at startup of the computing device, upon opening a new window or tab within an operating system or browser, upon selecting an icon or soft key within a user interface of a computing device, upon selection of a designated hard key by the user on a computing device, etc.

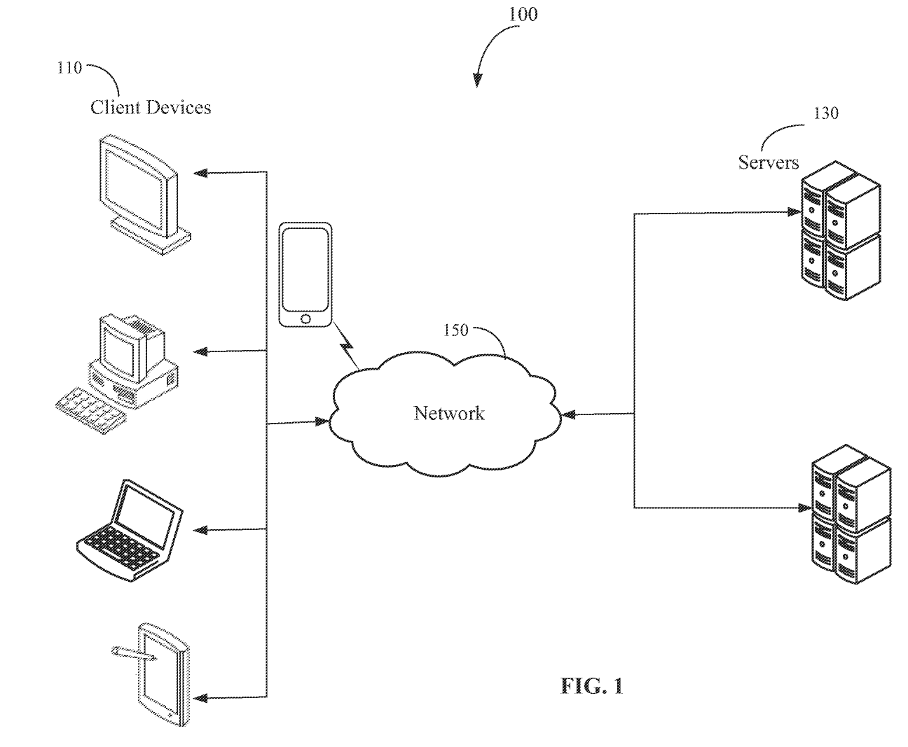

FIG. 1 illustrates an example architecture 100 for providing a graphical interface comprising components associated with activities suggested to a user for active applications. The architecture 100 includes servers 130 and client devices 110 connected over a network 150.

The client devices 110 can be, for example, desktop computers, mobile computers, wearable computers, tablet computers (e.g., including e-book readers), mobile devices (e.g., a smartphone or PDA), set top boxes (e.g., for a television), video game consoles, or any other devices having appropriate processor, memory, and communications capabilities. The client devices 110 can be any device having an appropriate processor and memory capability for determining suggested applications in association with at least one of the running applications, and providing a graphical interface that includes graphical components for switching to corresponding suggested applications. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

Each of the client devices 110 is configured to provide, for display, a graphical interface that includes graphical components for switching to corresponding suggested activities. As stated above, the graphical components provided for display in the graphical interface are selected for display in the graphical interface based on running applications. Among many different graphical components of the suggested activities, associated with at least one running application, a subset of the associated graphical components can be selected for display in the graphical interface because of user activity information. For example, the user activity information may indicate that the user has recently interacted with a particular suggested application or a similar application after opening a particular application, interacts with the particular suggested application frequently, the particular suggested application is relevant based on the current time or date, or the particular suggested application has for some reason become particularly relevant to the user.

The user activity information can be collected and stored locally in a memory of the client device 110. The user activity information may also be supplemented with user activity information from a server 130 over the network 150, for example, with user activity information from another client device 110 associated with the user uploaded and stored on the server 130 in order to synchronize user activity information for the user in a single or multiple location, namely, single or multiple servers 130.

In addition, the suggesting application 224 may suggest activities that are anticipated to be desired by the user based on the user's activity information, even though contextually related activities may not have been launched currently by the user.

Moreover, in one exemplary embodiment of the present disclosure, if the suggesting application 224 determines that the user has accessed an on-line provider to view a news article directed to a particular topic, the suggesting application 224 may suggest a link to another provider based on an anticipation that the user might also be interested in another news article of the same particular topic from another provider, which may be known based on the user activity information.

In another exemplary embodiment of the present disclosure, the suggesting application 224 may suggest activities based on the type of the client device.

Although many examples provided herein describe user activity information being stored in memory, each user must grant explicit permission for such user activity information to be stored. The explicit permission may be granted using privacy controls integrated into the disclosed system. Each user is provided notice that such user activity information will be stored with such explicit consent, and each user may at any time end having the user activity information stored, and may delete the stored user activity information. The stored user activity information may be encrypted to protect user security.

The user can at any time delete the user activity information from memory and/or opt out of having the user activity information stored in memory. Additionally, the user can, at any time, adjust appropriate privacy settings to selectively limit the types of user information stored in memory, or select the memory in which the user activity information is stored (e.g., locally on the user's device as opposed to remotely a server). In many examples, the user activity information does not include and/or share the specific identification of the user (e.g., the user's name) unless otherwise specifically provided or directed by the user.

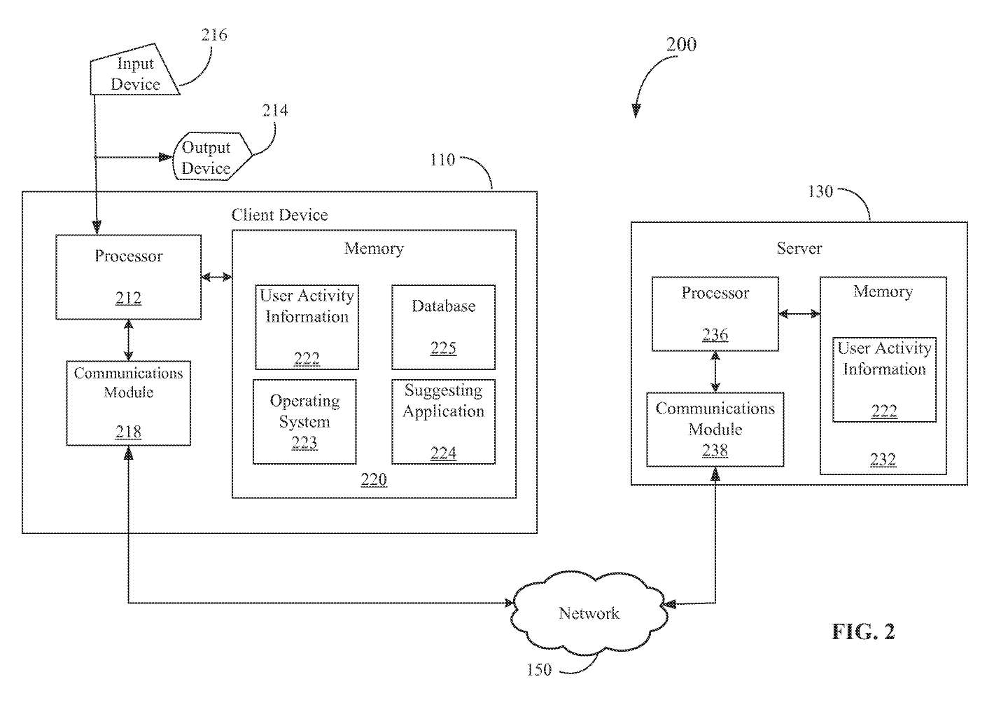

FIG. 2 is a block diagram 200 illustrating an example server 130 and client device 110 according to certain aspects of the disclosure. The client device 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards.

The client device 110 includes a processor 212, the communications module 218, and a memory 220 that includes an operating system 223, a suggesting application 224, and a database 225 of stored suggested applications and corresponding applications opened by the user. The suggesting application 224 can be, for example, a web browser or document viewer to identify applications that contextually correspond to running applications. The database 225 also includes graphical components that correspond to, for example, applications, links to networked content, files, and notifications (e.g., from messaging applications, social networks, or other applications). The memory 220 also includes user activity information 222. The user activity information 222 can be collected from suggesting application 224 or from the operating system 223. For example, in certain aspects, the user activity information 222 can be collected from suggesting application 224 based on the user prior history of running particular applications and opening applications suggested by suggesting application 224, which contextually correspond to the particular applications.

The user activity information 222 includes, for example, a preference of the user selecting a particular graphical component displayed for switching to a particular suggested activity after opening a particular application (e.g., how recently and frequently the particular suggested activity was accessed or performed).

Moreover, each particular suggested activity can be associated with a weighted value that is calculated based on the user activity. For example, a weight value may be generated based on certain distinct values associated with each of the frequency of the user performing or otherwise engaging with the particular suggested activity, how recently the particular suggested application was performed. For instance, if a suggested activity is particularly resource intensive (e.g., processor or memory intensive), then the suggested activity may be given a lower weight value on a client device 110 that is a mobile device than a client device 110 that is a non-mobile device. As another example, a suggested activity may be given a higher weight value if it is interacted with more frequently by a user than other suggested activities.

The client device 110 includes an input device 216, such as a touch input, keyboard, or mouse, and an output device 214, such as a display (e.g., touchscreen display). The processor 212 of the client device 110 is configured to execute instructions, such as instructions physically coded into the processor 212, instructions received from software in memory 240, or a combination of both. For example, the processor 212 of the client device 110 executes instructions to determine applications to be suggested to the user and that were determined to be contextually related to currently open applications. The processor 212 of the client device 110 is also configured to select a subset of the suggested applications based on the user activity information 222, and provide a graphical interface to display on the client device 110 (e.g., using the output device 214) graphical components corresponding to the subset of suggested applications. The graphical interface can be generated locally by the client device 110 or generated by the server 130 and provided to the client device 110 over the network 150. The graphical components can be displayed as icons that correspond to the selected subset of suggested applications and are arranged on a single surface of the graphical interface.

The graphical components are selectable (e.g., using the input device 216) to launch respective suggested activities. The graphical components can be ordered for display based on the frequency of the user switching to a corresponding suggested activity.

The graphical interface can be displayed on a display of a client device next to the displayed interfaces/windows of currently opened applications. Alternatively, the graphical interface may be displayed within a window of an opened application that is currently in focus on the display of the client device 110, such as within a new tab page of a web browser. The graphical interface can also be displayed by an operating system of the client device 110, such as within a task bar.

As discussed above, the graphical components and corresponding suggested activities can be synchronized across multiple client devices 110 associated with a user, such that the suggesting application 224 of each client device 110 can display a recently selected subset of suggested activities when a corresponding particular application is opened again by the user.

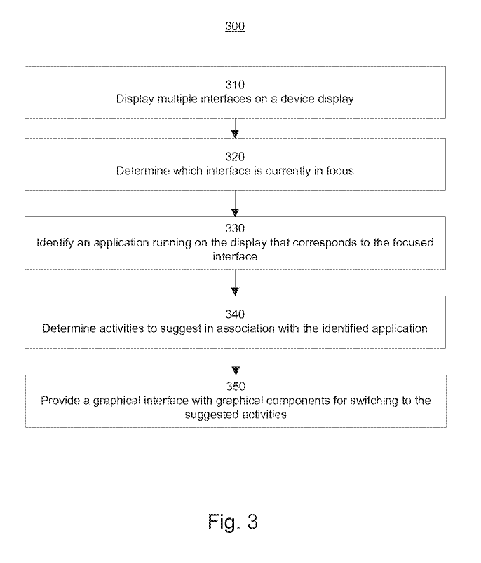

FIG. 3 illustrates an example process 300 for determining one or more suggested activities to a user of a device based a set of applications running on the device, and for providing a graphical interface comprising components associated with the one or more suggested activities. While FIG. 3 is described with reference to FIG. 2, it should be noted that the process steps of FIG. 3 may be performed by other systems.

The process 300, performed by the suggesting application 224, begins once multiple applications are running on the client device 110. For example, the applications may have been opened by a user of the client device 110, triggered by already opened applications, or a combination of both. The process 300 is configured to generate and display a plurality of interfaces on a display of the client device 110, each of which corresponds to one of the plurality of running applications, at step 310.

At Step 320, the process 300 is configured to determine, from among the plurality of multiple interfaces, an interface that is currently in focus on the display. The process 300 identifies a first running application that is one of the plurality of running applications that corresponds to the currently in focus interface, at step 330. In one example aspect of the present disclosure, the multiple interfaces correspond to at least one of windows or browser sessions respectively corresponding to the multiple applications.

At step 340, the process 300 is configured to determine one or more suggested activities, each of which corresponds to an activity for suggesting to the user to switch to and is associated with the first running application. In one aspect of the present disclosure, the one or more suggested activities are determined based on prior user history of the first application in association with the one or more suggested activities. In another aspect of the disclosure, the one or more suggested activities are determined based on functionality or other context of the first application. The suggested activities may be other applications or content, for example.

At step 350, the process 300 generates and provides a graphical application or interface for display. The graphical interface includes one or more graphical components, each of which can be used by the user for switching to a respective one of the one or more suggested activities.

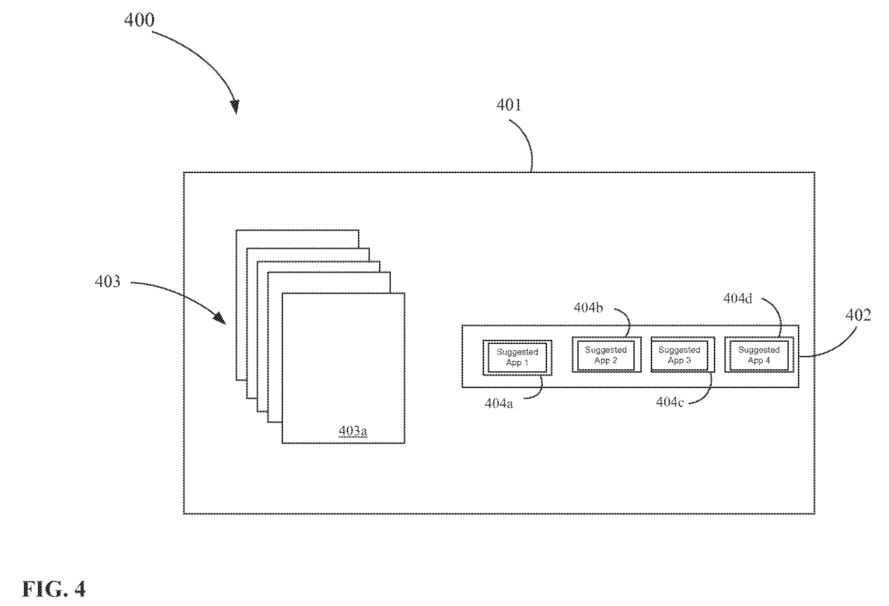

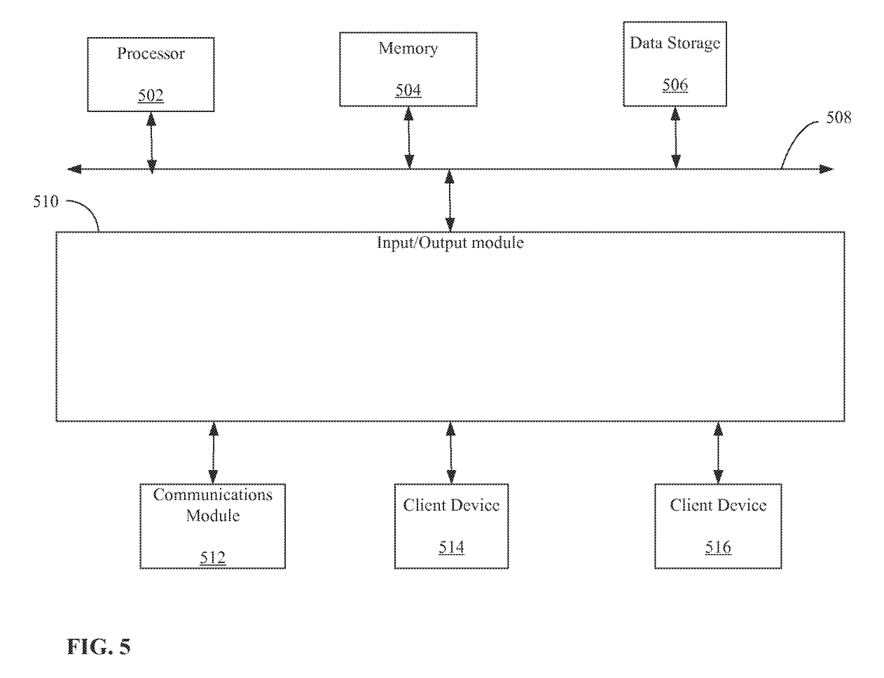

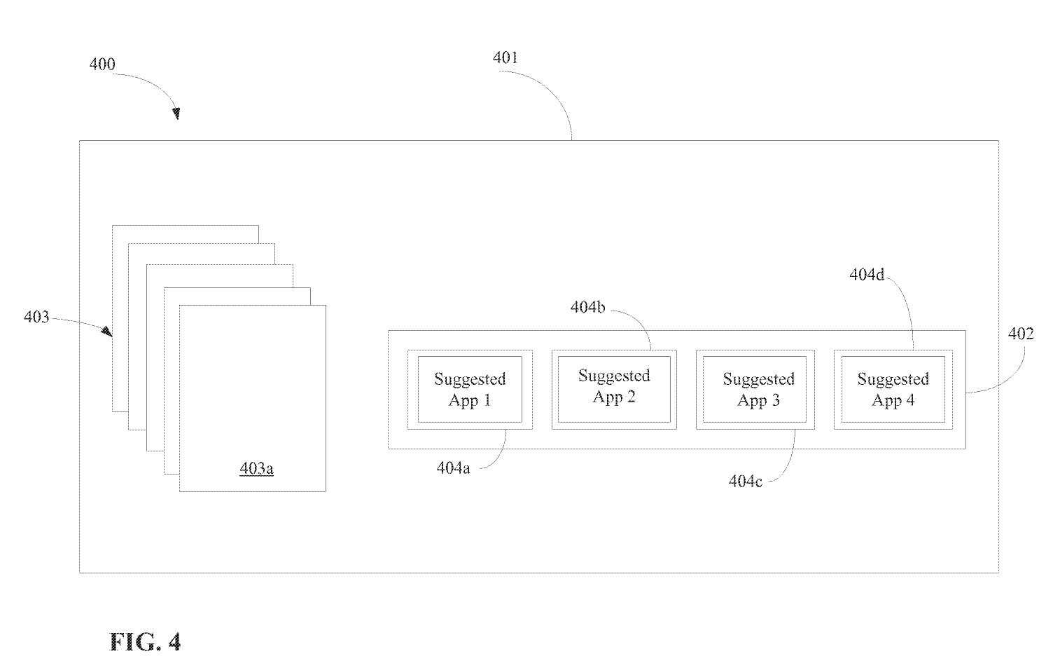

FIG. 4 is an example illustration 400 of a graphical interface 402, displayed on a display 401 of the client device 110, which includes interfaces 403 each of which corresponds to a running application with interface 403a being the interface currently in focus, and graphical components 404a-404d, each of which corresponds to one of the suggested activities. Alternatively, the graphical interface 402 may be displayed on the in-focus interface 403a, or in any other location of the display 401.

As stated above, alternatively, a subset of the graphical components is selected for display based on user activity information, which includes a preference of the user of the corresponding suggested activities, and which enables the suggesting application to determine new relevance of the corresponding suggested activities to the user. Moreover, a percentage of the subset of graphical components may correspond to suggested activities that are anticipated to be desired by the user based on his/her user activity information, even though contextually related activities may not have been launched currently by the user.

In an exemplary embodiment, the subset of graphical components correspond to suggested activities that were determined based on prior user activity/history of the first application in association with the one or more suggested activities.

For example, if the in-focus displayed interface includes a news article provided on-line by a news provider, one of the graphical components may include a link to another news article that is anticipated to be of interest to the user, and which may be provide on-line by the same provider or by another news provider.

In another exemplary embodiment of the present disclosure, the subset of graphical components corresponds to suggested activities that were selected by the suggesting application based on the type of the client device.

As shown, the plurality of graphical components are displayed next to the displayed interfaces 403, and can be arranged in a select order based on a user frequency of switching to their corresponding suggested activities. Each icon is selectable to launch a respective suggested application, a content element, or a web page associated with the corresponding running application. Alternatively, as stated above, the graphical interface may be displayed within a window of an opened application that is currently in focus on the display of the client device 110, such as within a new tab page of a web browser. The graphical interface can also be displayed by an operating system of the client device 110, such as within a task bar. In addition, the graphical interface 402 may include a search interface (not shown), which may be configured to search the memory 220 of the client device 110 or the World Wide Web for results responsive to a query entered into the search interface. In one embodiment of the disclosure, this search interface may be used by the user to query for a previously provided suggested activity, and for which there is no corresponding displayed graphical component.

FIG. 5 conceptually illustrates an example electronic system with which some implementations of the subject technology can be implemented. In certain aspects, the computer system 500 may be implemented using hardware or a combination of software and hardware, either in a dedicated server, or integrated into another entity, or distributed across multiple entities.

Computer system 500 (e.g., client device 110 and server 130) includes a bus 508 or other communication mechanism for communicating information, and a processor 502 (e.g., processor 212 and 236) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigmatic languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Example input/output modules 510 include data ports such as USB ports. The input/output module 510 is configured to connect to a communications module 512. Example communications modules 512 (e.g., communications modules 218 and 238) include networking interface cards, such as Ethernet cards and modems. In certain aspects, the input/output module 510 is configured to connect to a plurality of devices, such as an input device 514 (e.g., input device 216) and/or an output device 516 (e.g., output device 214). Example input devices 514 include a touchscreen, keyboard, or a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 516 include display devices, such as a LED (light emitting diode), CRT (cathode ray tube), or LCD (liquid crystal display) screen, for displaying information to the user.

According to one aspect of the present disclosure, the client 110 and server 130 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client device and server are generally remote from each other and typically interact through a communication network. The relationship of client device and server arises by virtue of computer programs running on the respective computers and having a client device-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 502 for execution. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in he description or the claims, such term is intended to be inclusive in a manner similar to the term “comprise” as “comprise” is interpreted when employed as a transitional word in a claim. A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. A computer-implemented method comprising:
displaying multiple interfaces on a display of a device, the multiple interfaces respectively corresponding to multiple applications running on the device;
determining, from among the multiple interfaces, an interface that is currently in focus on the display;
identifying a first application, from among the multiple applications, that corresponds to the determined interface;
determining one or more suggested activities based on the first application, wherein the one or more suggested activities correspond to at least one of an application or content different from the first application; and
providing a graphical interface for display, wherein the graphical interface comprises one or more graphical components, each graphical component for launching a respective one of the one or more suggested activities,
wherein the one or more suggested activities are determined based on user activity information corresponding to an access frequency of the one or more suggested activities on the device and how recently the one or more suggested activities was accessed.

2. The computer-implemented method of claim 1, wherein the multiple interfaces correspond to at least one of windows or browser sessions respectively corresponding to the multiple applications.

3. The computer-implemented method of claim 1, wherein the one or more suggested activities are determined based on prior user history of the first application in association with the one or more suggested activities.

4. The computer-implemented method of claim 1, wherein the one or more suggested activities are determined based on functionality or other context of the first application.

5. (canceled)

6. The computer-implemented method of claim 1, wherein each of the one or more suggested activities is associated with a weighted value that is calculated based on the user activity information.

7. The computer-implemented method of claim 1, wherein the user activity information comprises activity information for a user obtained from a server over a network.

8. The computer-implemented method of claim 7, wherein the user activity information obtained from the server comprises user activity information obtained from another computer device associated with the user.

9. The computer-implemented method of claim 1, wherein the one or more suggested activities are determined based on a type of the device.

10. The computer-implemented method of claim 9, wherein the device is a mobile computer, a wearable computer, a tablet computer, or a mobile device.

11. A system comprising:
one or more processors; and
a memory comprising processor-executable instructions, which when executed by the one or more processors cause the system to:
display multiple interfaces on a display of a device, the multiple interfaces corresponding to at least one of windows or browser sessions respectively corresponding to multiple applications running on the device;
determine, from among the multiple interfaces, an interface that is currently in focus on the display;
identify a first application, from among the multiple applications, that corresponds to the determined interface;
determine one or more suggested applications based on the first application, wherein the one or more suggested applications correspond to at least one application different from the first application; and
provide a graphical interface for display, wherein the graphical interface comprises one or more graphical components, each graphical component for launching a respective one of the one or more suggested applications,
wherein the one or more suggested activities are determined based on user activity information corresponding to an access frequency of the one or more suggested activities on the device and how recently the one or more suggested activities was accessed.

12. The system of claim 11, wherein the one or more suggested applications are determined based on prior user history of the first application in association with the one or more suggested applications.

13. The system of claim 11, wherein the one or more suggested applications are determined based on functionality or other context of the first application.

14. (canceled)

15. The system of claim 11, wherein each of the one or more suggested applications is associated with a weighted value that is calculated based on the user activity information.

16. The system of claim 15, wherein the user activity information comprises activity information for a user obtained from a server over a network.

17. The system of claim 16, wherein the user activity information obtained from the server comprises user activity information obtained from another computer device associated with the user.

18. The system of claim 11, wherein the one or more suggested applications are determined based on a type of the device.

19. A non-transitory machine-readable storage medium comprising machine-readable instructions for causing a processor to execute a method comprising:
displaying multiple interfaces on a display of a device, the multiple interfaces respectively corresponding to multiple applications running on the device;
determining, from among the multiple interfaces, an interface that is currently in focus on the display;
identifying a first application, from among the multiple applications, that corresponds to the determined interface;
determining one or more suggested activities based on the first application, wherein the one or more suggested activities correspond to at least one of an application or content different from the first application; and
providing a graphical interface for display, wherein the graphical interface comprises one or more graphical components, each graphical component for launching a respective one of the one or more suggested activities,
wherein the one or more suggested activities are determined based on user activity information corresponding to an access frequency of the one or more suggested activities on the device and how recently the one or more suggested activities was accessed.

20. The non-transitory machine-readable storage medium of claim 19, wherein each of the one or more suggested activities is associated with a weighted value that is calculated based on user information.
